(19) United States
(12) Patent Application Publication
(10) Pub. No.: US 2024/0123445 A1
(43) Pub. Date: Apr. 18, 2024

(54) Pressure Driven Microfluidic Chip And Method For Delivering A Sample At A Determined Flow Rate

(71) Applicants: Micronit Holding B.V., Enschede (NL); Enzyre B.V., Nijmegen (NL)

(72) Inventors: Elwin Xander Vrouwe, Euschede (NL); Henrieke Anne Meijer, Enschede (NL); Marko Theodoor Blom, Delden (NL)

(73) Assignees: Micronit Holding B.V., Enschede (NL); Enzyre B.V., Nijmegen (NL)

(21) Appl. No.: 18/276,924

(22) PCT Filed: Feb. 10, 2022
(86) PCT No.: PCT/NL2022/050066

§ 371 Date: Aug. 11, 2023

(30) Foreign Application Priority Data
Feb. 11, 2021 (NL) 2027544

(51) Int. Cl. B01L 3/00

(52) U.S. Cl. CPC B01L 3/502746; B01L 3/50273; B01L 2200/0684; B01L 2300/0867; B01L 2400/0487; B01L 2400/0688

(57) ABSTRACT

The invention relates to a pressure driven microfluidic chip for delivering a first liquid at a determined flow rate, said chip comprising a first inlet, a container connected to the first inlet, a second inlet connected to the container via a first passage, a second passage connecting the container to an outlet, wherein the first passage has a first resistance to liquid flow, and the second passage has a second resistance to liquid flow. The first resistance may be higher than the second resistance. The invention also relates to a pressure driven method of delivering a first liquid at a determined flow rate comprising using a chip first a first and second passage, wherein the first passage has a first resistance to the flow of the first liquid, and the second passage has a second resistance to flow of the second liquid.

### FIELD OF THE INVENTION

The invention relates to a pressure driven microfluidic chip for delivering a first liquid at a determined flow rate.

### BACKGROUND OF THE INVENTION

Various applications for microfluidic chips exist. For instance, the chips may be used in lab-on-a-chip applications or point-of-care solutions. In many applications, establishing a determined flow rate of the first liquid is critical for the correct operation of the chip. As an example, when submitting a diluted sample to a concentration sensitive test, it is important the sample is diluted at a predetermined ratio. As the dilution ratio depends on the flow rates of the sample and the diluent, variations in the flow rate of the sample directly affect the test results.

The flow rate of any liquid in a pressure driven microfluidic is determined by a combination of factors, amongst which the geometry and dimension of the passage through which the liquid flows, and the viscosity of the liquid.

However, in certain applications the viscosity of the liquid to be delivered may not be exactly known, or may vary. An unknown variation in viscosity introduces additional uncertainty in any quantity determined on the basis of the viscosity, such as the flow rate.

It is an object of the invention to provide a microfluidic chip that is less susceptible to variation in viscosity of the first liquid, in order to deliver the first liquid at a determined flow rate, preferably with a smaller uncertainty.

### SUMMARY OF THE INVENTION

This object is achieved by a pressure driven microfluidic chip for delivering a first liquid at a determined flow rate, said chip comprising a first inlet, for letting the first liquid into the chip, a container connected to the first inlet, for at least temporarily containing an amount of first liquid, a second inlet connected to the container via a first passage, for letting in a second liquid into the chip, a second passage connecting the container to an outlet, allowing flow of the first liquid into the second passage, thereby delivering the first liquid, wherein the first passage has a first resistance to liquid flow, and the second passage has a second resistance to liquid flow.

By providing the first and second passages separately from each other, the first and second liquid encounter the different resistances to flow. When the first resistance is significant with respect to the second, for instance higher than the second, the first resistance determines the flow rate to a relatively large extent. Thus, the second liquid has a relatively large influence on the flow ratio, for example as compared to the influence of the first liquid. Therefore, a second liquid with a relatively accurately known viscosity, and/or with a relatively small variation, can be chosen to accompany a first liquid, e.g. a sample. Accordingly, variations in the viscosity of the first liquid will cause variations in the flow rate to a lesser extent, as the more constant effect of the second liquid also contributes to the flow rate.

By increasing the difference in resistance, a desired robustness against variation in viscosity of the first liquid can be obtained. By increasing the ratio of the first resistance over the second resistance, a larger reduction of the effect of the viscosity variation on the flow rate will be achieved. For instance for when the two resistances are equal, the relative variation in flow due to a certain viscosity variation will be halved.

Depending on the application the first resistance can be chosen to be (approximately) equal to the second resistance or to be larger than the second resistance. However, advantageous effects can also be observed when the first resistance equals a tenth of the second resistance or half of the second resistance.

In particular, the first resistance may be at least ten times higher than the second resistance. Accordingly, the influence of the first resistance will be an order of magnitude higher, thereby reducing the influence of viscosity variations in the first liquid also approximately an order of magnitude, which is sufficient for many practical applications.

The first and second resistance may be defined for a liquid of similar or equal viscosity, or for the same liquid. When in use, the first and second resistance may be defined for the respective liquids used, and as such may be defined even for dissimilar viscosities.

Pressure driven chip as defined herein also comprises capillary pressure driven chip, as for the flow of fluid the source of pressure is irrelevant.

In an embodiment of the chip, the chip further comprises a third passage connected to the second passage downstream of the container for supplying a third liquid to the second passage, the chip thereby being suitable for mixing the third liquid with the first liquid.

By mixing the first liquid with a third liquid, a device can be obtained that allows mixing liquids. As described above, the influence of viscosity variations in the first liquid can be compensated to achieve a relatively constant or accurately known flow rate. By then mixing the first liquid with a third liquid, a relatively constant or accurately known mixing ratio can be obtained, since the mixing ratio depends on the ratio of flow rates of the first and second liquid. As such, at a predefined flow rate of the third liquid, a predefined mixing ratio can be obtained with the chip according to this embodiment, even if the first liquid has a varying viscosity.

The third passage may intersect with the second passage downstream of the container. The third passage may be defined as upstream of the intersection, e.g. towards an input for the third liquid. The second passage may run from the container to the outlet. A portion of the second passage may be upstream of the intersection, whereas another portion of the second passage may be downstream of the intersection.

In another embodiment of the chip, the chip further comprises a third inlet connected to the third passage. The third inlet may be used to separately supply a third liquid.

Alternatively it is possible to connect the third passage to the second inlet, so that the third passage and the first passage share the second inlet. Accordingly, the same inlet may be used for providing liquid to the third and first passages. Such a device allows using the same liquid as first and third liquid, and is relatively simple in use, as it requires less separate means, such as conduits, for providing liquid.

In yet another embodiment of the chip, a minimum cross sectional area of the first passage is smaller than a minimum cross sectional area of the second passage. The smaller minimum cross sectional area can create a higher resistance to flow.

In yet another embodiment of the chip, the minimum cross sectional area of the first passage is smaller than a minimum cross sectional area of the third passage. Accordingly, the first passage may have a higher resistance to liquid flow (for instance of the same liquid) than the third passage. This may aid in delivering smaller portions of first liquid in into a mass of third liquid.

The cross sectional area is defined in the transversal direction, i.e. perpendicular to a flow direction defined by the passage and/or to a longitudinal direction of the passage.

As the minimum cross sectional area defines the resistance to flow to the largest extent, the cross sectional area at other locations of the passages may be less relevant or not relevant at all.

In yet another embodiment of the chip, the chip comprises a capillary stop valve between the container and the first passage and/or a capillary stop valve between the container and the second passage.

The capillary stop valves upstream and downstream of the container may allow filling the container with first liquid, thereby essentially preparing or pre-loading the chip for delivering the first liquid. After preparing or pre-loading, the stop valves may be triggered by supplying the second and/or third liquid in order to start delivering the first liquid at a desired moment.

The capillary stop valve(s) may form a flow restriction in the first and/or second passage, in particular by constituting the minimum cross sectional flow area for the respective passage.

In yet another embodiment of the chip, the chip further comprises an absorber connected to the first inlet. Using an absorber connected to the first inlet, for instance in parallel to the container, the container may be prevented from overflowing, by the absorber absorbing excess first liquid. This is particularly useful in combination with one or more capillary stop valves, as the absorber could aid in preventing excess fluid from triggering the stop valve(s).

The chip may comprise a vent connected to the first passage at a position beyond the container as seen from the inlet.

The vent can be used to let out air present in the container, in order to fill the container with first liquid. By placing the vent beyond the container, the second liquid will first reach the container before reaching the vent. Accordingly, the second liquid may not, or at least not initially, exit the vent. The vent may in particular be placed after a capillary stop valve connecting the first passage with the container, so that the second liquid triggers the stop valve before reaching the vent.

The invention also relates to a pressure driven method of delivering a first liquid at a determined flow rate, the method comprising the steps of:
a) at least partly filling a container with an amount of the first liquid;
b) causing a second liquid to flow into the container via a first passage, thereby forcing at least some of the first liquid out of the container, in order to discharge said at least some of the first liquid through a second passage;
wherein the first passage has a first resistance to the flow of the second liquid, and the second passage has a second resistance to flow of the first liquid. The first resistance may be higher than the second resistance.

As the first resistance contributes to defining the flow rate, the flow rate is at least partially defined by the viscosity of the second liquid. Therefore, the influence of viscosity variations in the first liquid are reduced.

If first resistance is higher than the second resistance, the first resistance is more significant for the flow rate than the second resistance. Accordingly, using the second liquid in the first passage for pushing out the first liquid, allows defining the flow rate of the first liquid to a relatively large extent using the second liquid. As such, influences of viscosity variations of in the first liquid are compensated. In particular, the second liquid can be chosen to have a known and/or well defined and/or constant viscosity to increase accuracy.

Of course, a suitable ratio between the first and second resistance can be chosen, such as 1:10, 1:2, 1:1. In particular, a ratio of first to second resistance of >1:1 or >10:1 is considered.

The invention also relates to a method for mixing the first liquid and a third liquid, the method comprising the method above of dispensing the first liquid and supplying the third liquid downstream of the container in order to mix the first liquid with the third liquid at a predetermined concentration of first liquid.

By mixing the first and third liquid in this way, a mixture may be obtained in which the ratio of first liquid to third liquid is relatively accurate.

In particular, the first liquid may be supplied via a first inlet, and the second liquid may be supplied via a separate, second inlet.

Using two separate inlets allows preloading the first liquid.

It is particularly advantageous when the viscosity of the second liquid is higher than a viscosity of the first liquid.

In this case, the flow resistance of the second liquid will be relatively high, thereby having more influence on the flow rate of the first liquid. Therefore, viscosity variations in the first liquid have less effect on the flow rate.

Advantageously, the first resistance is at least approximately ten times higher than the second resistance.

When the first resistance is so much higher, the variations in viscosity of the first liquid become of little practical relevance.

As an example, the following use case is considered. Blood plasma typically has a viscosity of ca. 1.5 mPa·s. However, from sample to sample, the viscosity may change. The spread of the viscosity is expressed as variation in the viscosity value. In the case of blood plasma, the variation is often reported to be ca.±0.2 mPa·s, i.e. ca. 13% of the viscosity value. For analysis, blood plasma samples are often diluted using aqueous buffers. Of course, other buffers may be employed. In this example, aqueous buffers are used because they are widely used. In general, aqueous buffers have a viscosity of around 1 mPa·s, thus being relatively close to the sample's viscosity. The two viscosities are within the same order of magnitude. When mixing the buffer and the sample using a pressure driven system, the mixing ratio is defined by the flow rates of the buffer and the sample. In general, without applying the inventive principle as described herein, the flow rate is determined by channel geometry and viscosity of the sample and the driving pressure differential. As such, variations in the viscosity of the blood plasma influence the mixing ratio to a relatively large extent. This detriments experimental results to a relatively large extent.

By using a second liquid in a first passage, the negative effect of viscosity variations in the sample can be accounted for. In particular, when the first passage has a resistance to flow approximately 10 times larger than the resistance to flow of a second passage through which the sample flows, most of the flow resistance is encountered in the first passage. The flow rate is therefore determined to a relatively large extent in the first passage. Even using an aqueous buffer as second liquid, satisfactory results can be obtained due to the higher flow resistance of the first passage. In principle, if the resistance to flow of the first passage is about 10 times higher than that of the second passage, the effect of the viscosity variations is reduced by about 10 times. Therefore, the apparent variation in viscosity as seen from the flow rate is reduced to ca. 1.3%, instead of the actual 13%. The same result can be obtained by using a second liquid with a relatively high viscosity as compared to the first liquid, with or without the higher resistance in the first passage.

It must be noted that this example is illustrative only. Of course the numbers may vary, and the current disclosure can be used for other types of samples and buffers as well. Further it is noted that the actual resistance to flow is also influence by other factors, such as channel length, channel shape, and resistance of e.g. inlet and outlet. However, given the current disclosure it is submitted that the skilled person understands that introducing a resistance to flow can aid in reducing the influence of sample viscosity. The resistance to flow can be created in various ways, such as by including a small capillary stop valve, introducing a flow restrictor in the first passage, or by using a relatively viscous second liquid.

### BRIEF DESCRIPTION OF THE DRAWINGS

The invention will be further elucidated with reference to the attached figures, wherein:

FIGS. 1A and 1B schematically show a simplified embodiment of a pressure driven microfluidic chip for delivering a first liquid at a determined flow rate;

FIGS. 2A and 2B schematically show a simplified embodiment of a pressure driven microfluidic chip for mixing a first and third liquid; and

FIGS. 3A-3D schematically show another embodiment of a microfluidic chip for mixing a first and third liquid at a determined flow rate.

### DETAILED DESCRIPTION OF THE INVENTION

Across the figures, like elements are referred to using like reference numerals. Like elements of different embodiments are referred to using reference numerals increased by one hundred (100).

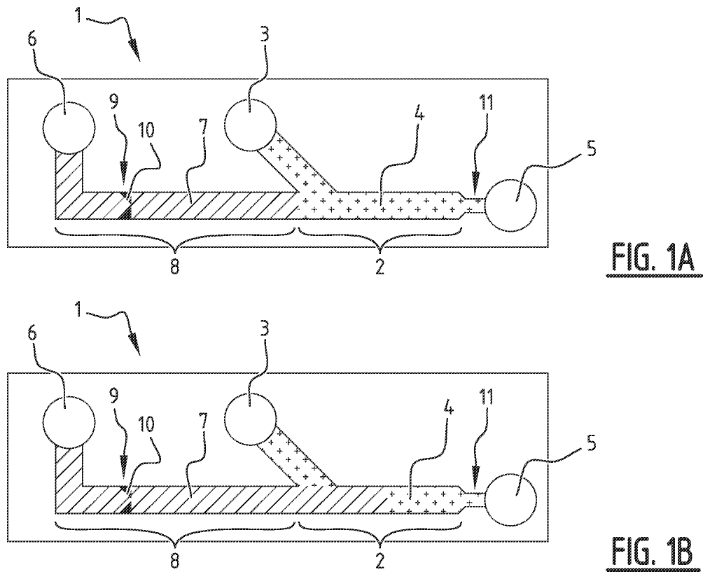

FIGS. 1A and 1B show a simplified microfluidic chip 1. The chip 1 has a container 2 which can hold liquid. In the shown embodiment, the container 2 is formed by a segment of a microfluidic channel 2. Although not shown here, the channel 2 is provided as a trough in a first layer of the chip 1, and a second layer seals the channel 2 and other structures of the chip 1. Inlet and outlets can be created by making a hole in the first or second layer of the chip 1. The chip 1 also comprises a first inlet 3. The first inlet 3 is connected to the container 2, so that a first liquid 4 can be let into the container 2 via the first inlet 3. On the other side, the container 2 is connected to an outlet 5 via a second passage 11. First liquid 4 from the container 2 can therefore exit the chip 1 via the outlet 5. The chip 1 has a second inlet 6. Via the second inlet 6, a second liquid 7 can be let into the chip 1. The second inlet 6 connects to the container 2 via a first passage 8, which in this example is also a segment of a microfluidic channel 8.

The microfluidic chip 1 of FIGS. 1A and 1B is operated as follows. After first liquid 4 has been let into the container 2 (see FIG. 1A), second liquid 7 is added through the second inlet 6. The second liquid 6 therefore pushes the first liquid 4 out of the chip via the outlet 5 (see FIG. 1B). To prevent the first liquid 4 from escaping through the first inlet 3, the first inlet 3 may be sealed, or a pressure may be applied thereto. Sealing the first inlet 3 makes sure no fluid flow is possible in the channel section between the inlet 3 and the channel 2, thereby avoiding influences this channel section may have on the flow rate.

The first passage 8 includes a narrowing 9, shown here using a funnel 10. The narrowing 9 causes a flow restriction in the first passage 8. Of course, other types of narrowing could also be used, or other types of flow restrictions could be used. The flow restriction 9 creates a relatively high resistance to flow, so that the first passage 8 has a relatively high resistance to flow. The second passage 11 has no narrowing 9, so that its resistance to flow is lower. The flow rate of the first liquid 4 is determined by the pressure drop from the second inlet 6 to the outlet, and the resistance to flow of the first and second liquid 4, 7—when disregarding flow to or from the first inlet 3 at the same time. As the resistance to flow in the first passage 8 is relatively high, the first passage's 8 contribution to the flow rate is significant. The contribution of the second passage 11 is analogously less significant.

The chip 1 can thus be used to deliver the first liquid 4 at a determined flow rate, even if the viscosity of the first liquid 4 varies within a sample, or from sample to sample, or is not accurately known. By simply using a second liquid 7 of a known and relatively constant viscosity, the flow rate can be determined to a relatively large extent by the known second liquid 7 rather than by the sample first liquid 4. As such, the flow rate can be determined relatively accurately.

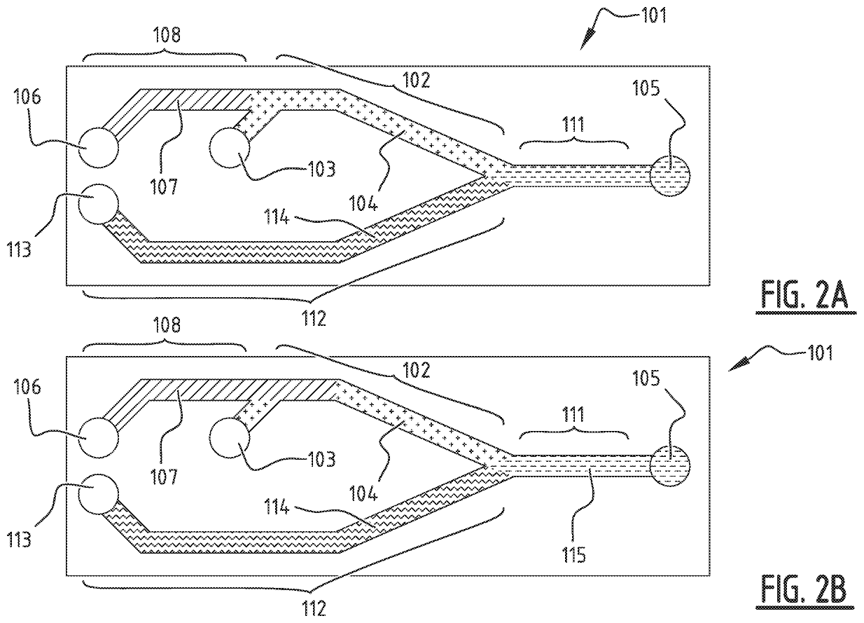

FIGS. 2A and 2B show a chip 101 that is similar to the chip 1 of FIGS. 1A and 1B. As such, only the difference will be described below. The chip 101 of FIGS. 2A and 2B has a third passage 112 that connects to the second passage 111 downstream of the container 102. The third passage has a third inlet 113, so that a third liquid 114 can be let into the third passage 112. As an alternative the third passage 112 could be connected to the second inlet 106, so that the second and third liquid 107, 114 are the same.

By driving the third liquid 114 at the same time as the second liquid 107, the two liquids merge in the second passage 111, where they will mix. As such, a mixed fluid 115 is delivered at the output 105. Depending on the liquids involved, different mixing behavior is observed.

Instead of restricting flow of the second liquid 107 by a flow restriction caused by the geometry of the first passage 108, the resistance to liquid flow in the first passage 108 is increased by choosing a second liquid 107 with a relatively high viscosity. Similar as to in the chip 1 of FIGS. 1A and 1B, the flow rate is therefore defined to a relatively large extent by second liquid 107 flowing in the first passage 108, so that the flow rate is not as much influenced by variations in the viscosity in the first liquid 104.

The mixing ratio between the first and third liquids 104, 114 is defined by the flow rates of the liquids 104, 114. As the flow rate of the first liquid 104 is defined to a relatively large extent by the flow resistance in the first passage 108, and to a lesser extent by flow of the first liquid 104, the mixing ratio is determined to a relatively large extent by the second liquid 107 flowing through the first passage 108. As such, the chip 101 of FIGS. 2A and 2B can be used for delivering a mixed fluid 115 at a predetermined mixing ratio.

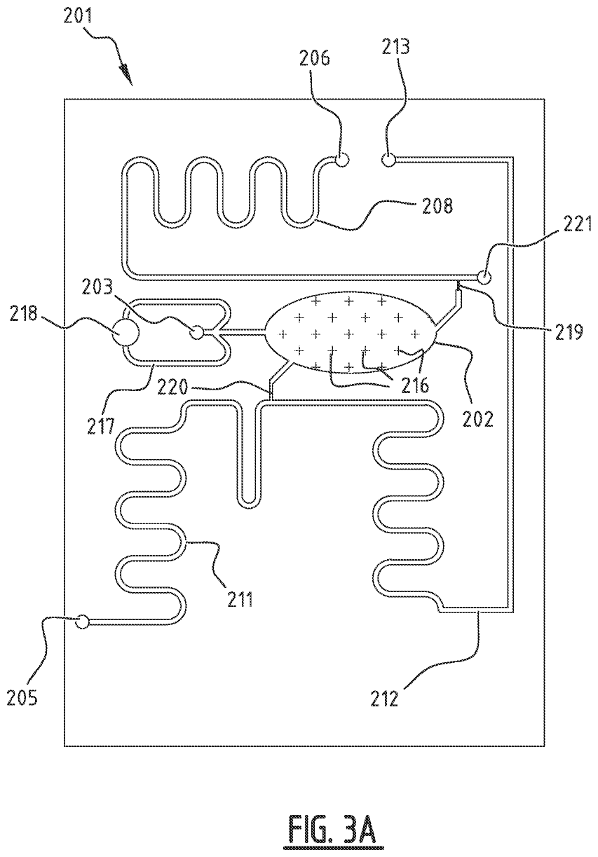

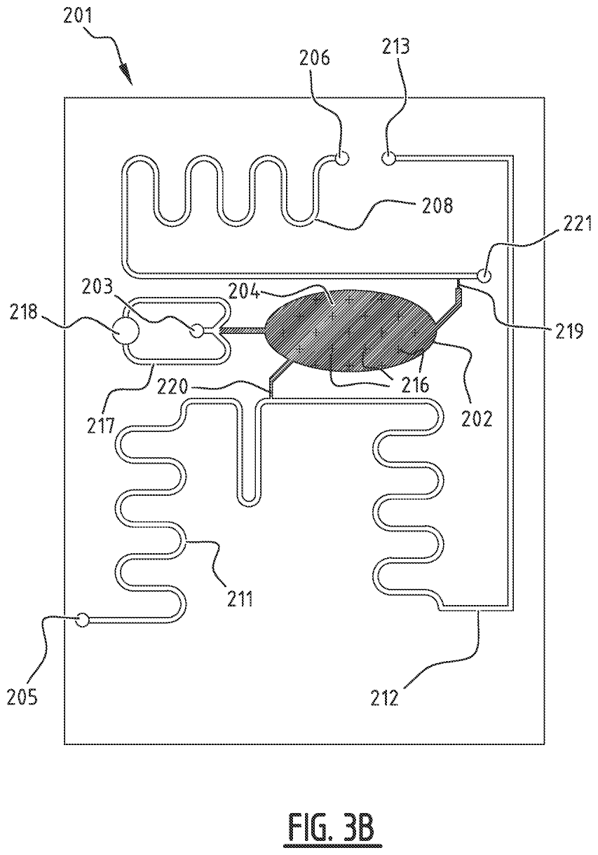

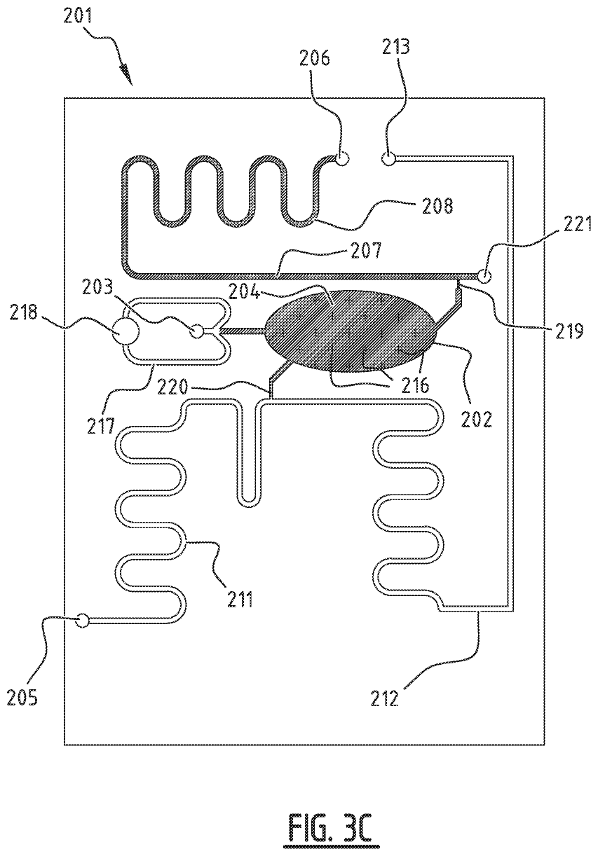

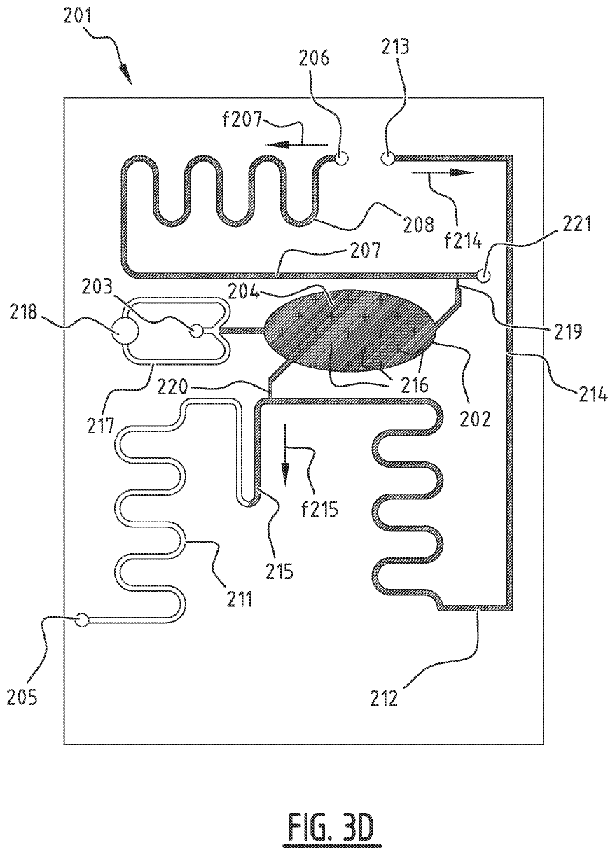

FIGS. 3A and 3B show a chip 201 which can be used for delivering a mixed fluid 215 at a predetermined mixing ratio, by reducing the influence of viscosity variations in a first fluid 204. The chip 201—shown empty in FIG. 3A—includes first, second and third inlets 203, 206, 213 and outlet 205. The chip 201 further includes a container 202. The container 202 in this example is formed by a chamber machined from a first layer of material of the chip 201, and closed by a second layer of material of the chip 201. Of course other production methods are also possible, such as embossing or etching. The passages 208, 211, 212 and other parts of the microfluidic flow system of the chip are formed in the same way. The container 202 includes pillars 216 to prevent collapsing. The first inlet 203 connects to the container 202. Near the first inlet, an overflow channel 217 is provided which connects to a wick 218. The second inlet 206 also connects to the container 202, via a first passage 208. The first passage 208 is separated from the container via a first capillary stop valve 219. Until triggered, the first capillary stop valve 219 stops liquid from exiting the container 202 into the first passage 208. The first passage 208 includes a vent 221, which is placed beyond the container 202 as seen from the second inlet 206. The outlet 205 is also connected to the container 202, via a second passage 211. The second passage 211 is separated from the container 202 via a second capillary stop valve 220. Until triggered, the second capillary stop valve 220 stops liquid from exiting the container into the second passage 211. Finally, the third inlet 213 is connected to the second passage via a third passage 212. The third passage 212 connects to the second passage 211 downstream of the second capillary stop valve 220, i.e. further towards the outlet 205. The capillary stop valves 219, 220 form the smallest cross sectional through flow areas of the first and second passages 208, 211 respectively. The cross sectional area of the first capillary stop valve 219 is smaller than the cross sectional area of the second capillary stop valve 220. As such, the resistance to flow is highest in the first capillary stop valve 219.

The chip 202 is used as follows. First, an empty chip 201 is provided (see FIG. 3A). Second, first liquid 204 is inserted through the first inlet 203 (see FIG. 3B). The first liquid 204 fills the container 202. During filling, air present in the container 202 exits through the vent 221. It is also possible air exits through the first, second and third passages 208, 211, 212 when the second and third inlets 206, 213 and the outlet 205 are left free during filling. If too much first liquid 216 is inserted, a surplus will flow via the bypass channel 217 towards the wick 218 in order to be absorbed. As such, the wick 218 prevents capillary stop valves 219, 220 from triggering when a surplus of first liquid 204 is supplied. Third, a second liquid 207 is let in through second inlet 206, until the first passage 208 is filled. During filling of the first passage 208, air from the first passage exits through the vent 221. When the second liquid 207 reaches the first capillary stop valve 219, said stop valve 219 is triggered, thereby allowing flow. However, as the second capillary stop valve 220 remains untriggered, both the first and second liquid 204, 207 stop flowing. Fourth, third liquid 214 is supplied via the third inlet 213 until the third passage 212 is filled. While filling, air exits the third passage 212 via the second passage 211 and the outlet 205. When the third liquid 214 reaches the second capillary stop valve 220, said stop valve 220 is triggered, thereby allowing flow. Then, by creating a pressure differential from the second and third inlets 206, 213 to the outlet 205, the second and third liquids 207, 214 will flow in the direction indicated by arrows f207 and f214 respectively (see FIG. 3D). As such, the second liquid 207 pushes the first liquid 204 out of the container 202, through the second capillary stop valve 220 into the second passage 211 towards the outlet 205. At the same time, third liquid also flows into the second passage 211 towards the outlet 205, so that the first and third liquid 204, 214 is mixed. The resulting mixed fluid 215 flows from the container 202 towards the outlet 205 as is shown using an arrow f215.

It is noted that while flowing, the second liquid 207 contacts the first capillary stop valve 219, and the first liquid 204 contacts the second capillary stop valve 220. Since the first capillary stop valve 219 is smallest, it has a relatively high resistance to flow. As such, the viscosity of the second liquid 208, in combination with the first capillary stop valve 219 is defining to a relatively large extent for the flow rate of the first liquid 204 downstream. As such, variations in the viscosity of the first liquid 204 are of less influence. The same principle can be employed by choosing a second liquid 208 with a higher viscosity than the first liquid 204, even without having different geometries for the capillary stop valves 219, 220 or the first and second passages 208, 211. Of course, a combination of these strategies is also possible.

Although the invention has been described hereabove with reference to a number of specific examples and embodiments, the invention is not limited thereto. Instead, the invention also covers the subject matter defined by the claims, which now follow.

1. A pressure driven method of delivering a first liquid at a determined flow rate, the method comprising the steps of:
a) at least partly filling a container with an amount of the first liquid;
b) causing a second liquid to flow into the container via a first passage, thereby forcing at least some of the first liquid out of the container, in order to discharge said at least some of the first liquid through a second passage;
wherein the first passage has a first resistance to the flow of the first liquid, and the second passage has a second resistance to flow of the second liquid, wherein the first resistance is higher than the second resistance.

2. The method according to claim 1, further comprising supplying a third liquid downstream of the container in order to mix the first liquid with the third liquid at a predetermined concentration of first liquid.

3. The method according to claim 2, wherein the first liquid is supplied via a first inlet, and the second liquid is supplied via a separate, second inlet.

4. The method according to claim 1, wherein a viscosity of the second liquid is higher than a viscosity of the first liquid.

5. The method according to claim 1, wherein the first resistance is at least approximately ten times higher than the second resistance.

6. A pressure driven microfluidic chip for delivering a first liquid at a determined flow rate, said chip comprising:
a first inlet, for letting the first liquid into the chip;
a container connected to the first inlet, for at least temporarily containing an amount of first liquid;
a second inlet connected to the container via a first passage, for letting in a second liquid into the chip;
a second passage connecting the container to an outlet, allowing flow of the first liquid into the second passage, thereby delivering the first liquid;
wherein
the first passage has a first resistance to liquid flow, and the second passage has a second resistance to liquid flow.

7. The chip according to claim 6, wherein the first resistance is higher than the second resistance.

8. The chip according to claim 6, further comprising a third passage connected to the second passage downstream of the container for supplying a third liquid to the second passage, the chip thereby being suitable for mixing the third liquid with the first liquid.

9. The chip according to claim 6, further comprising a third inlet connected to the second and/or third passage.

10. The chip according to claim 6, wherein a minimum cross sectional area of the first passage is smaller than a minimum cross sectional area of the second passage.

11. The chip according to claim 8, wherein a minimum cross sectional area of the first passage is smaller than a minimum cross sectional area of the second passage, wherein the minimum cross sectional area of the first passage is smaller than a minimum cross sectional area of the third passage.

12. The chip according to claim 6, comprising a capillary stop valve between the container and the first passage and/or a capillary stop valve between the container and the second passage.

13. The chip according to claim 6, further comprising an absorber connected to the first inlet.

14. The chip according to claim 6, further comprising a vent connected to the first passage at a position beyond the container as seen from the inlet.
